(19) United States
(12) Patent Application Publication
(10) Pub. No.: US 2013/0127429 A1
(43) Pub. Date: May 23, 2013

(54) Soft-stop Device and Power Converter Using the Same

(71) Applicant: Ciou-Fong Li, New Taipei City (TW)

(72) Inventor: Ciou-Fong Li, New Taipei City (TW)

(21) Appl. No.: 13/454,099

(22) Filed: Apr. 24, 2012

(30) Foreign Application Priority Data
Nov. 21, 2011 (TW) 100142517

(51) Int. Cl. G05F 1/10

(52) U.S. Cl. 323/282

(57) ABSTRACT

A soft-stop device for a power converter includes a first signal terminal for receiving a first signal corresponding to an output voltage of the power converter; a second signal terminal for receiving a shutdown signal for turning off the power converter; a discharge switch, coupled between the first signal terminal and a grounding terminal, for controlling an electrical connection between the first signal terminal and the grounding terminal according to a control signal; a sample-and-hold unit, for sampling the first signal received by the first signal terminal when the shutdown signal is received by the second signal terminal, to generate a shutdown reference voltage; and a shutdown control unit, for generating the control signal according to the first signal and the shutdown reference voltage.

### BACKGROUND OF THE INVENTION

1. Field of the Invention

The present invention relates to a soft-stop device and power converter, and more particularly, to a soft-stop device and power converter capable of directly sampling an output voltage of the power converter when shut down, and allowing the output voltage fully discharged.

2. Description of the Prior Art

A power converter is an important part of an electronic device, which can convert an input voltage to an output voltage having different voltage levels. In general, the power converter requires to ensure the output voltage returned to zero when shut down; otherwise, the power converter may not be activated from zero voltage level due to the residual output voltage when the power converter is turned on next time, and may cause circuit damaged or a countercurrent status of an inductor current flowing to a voltage input terminal.

Please refer to FIG. 1, which is a schematic diagram of a conventional power converter 10. The power converter 10 is a switching-mode buck converter, which can convert an input voltage VIN to an output voltage VOUT of lower level. The power converter 10 includes a control module 100, a power stage circuit 102 and a feedback circuit 104. The control module 100 compares a feedback signal VFB generated by the feedback circuit 104 and a reference voltage VRF, and generates driving signals VDRV and VDRV_B reversing to each other to the power stage circuit 102 accordingly. The power stage circuit 102 is composed of an upper gate switch N1, a lower gate switch N2, an inductor L and a capacitor C, and switches a connection between the input voltage VIN or a grounding terminal and the inductor L according to the driving signals VDRV and VDRV_B, so as to convert the input voltage VIN to the suitable output voltage VOUT via inductor-capacitor effect. The feedback circuit 104 is composed of resistors R1 and R2, which divides the output voltage VOUT via a voltage-dividing method, and deriving the feedback signal VFB. In other words, VFB=VOUT×R2/(R1+R2).

When shut down, the power converter 10 can set the reference voltage VRF to be zero, and the control module 100 may control the power stage circuit 102 according to a gap between the feedback signal VFB and the reference voltage VRF, to reduce the output voltage VOUT. However, the feedback signal VFB can not accurately correspond to a status of the output voltage VOUT. When a voltage-dividing ratio between the feedback signal VFB and the output voltage VOUT is too high, an offset between the feedback signal VFB and the reference voltage VRF may cause the output voltage VOUT to have residual voltage and can not be completely discharged to zero when the power converter 10 is shut down. Assuming the voltage-dividing ratio between the feedback signal VFB and the voltage VOUT is VFB: VOUT=1:5, and if the offset (e.g. 100 mV) between the feedback signal VFB and the output voltage VOUT occurs, it may cause the output voltage VOUT to have a proportional residual voltage (e.g. 500 mV) when shut down, and further worsen the voltage residual status when the output voltage VOUT is higher. When the power converter 10 is booted and the upper gate switch N1 is turned on next time, the output voltage VOUT remained on the capacitor C may cause a backflow current generated by the inductor L flowing to the voltage input terminal.

Therefore, it is a common goal in the industry to improve the voltage residual status when the power converter is shut down.

### SUMMARY OF THE INVENTION

It is therefore an objective of the present invention to provide a soft-stop device and related power converter thereof, for returning an output voltage of the power converter to zero when shut down.

The present invention discloses a soft-stop device for a power converter utilized for converting an input voltage to an output voltage. The soft-stop device includes a first signal terminal, for receiving a first signal corresponding to the output voltage; a second signal terminal, for receiving a shutdown signal for turning off the power converter; a discharging switch, coupled between the first signal terminal and a grounding terminal, for controlling an electrical connection between the first signal terminal and the grounding terminal according to a control signal; a sample-and-hold unit, coupled to the first signal terminal and the second signal terminal, for sampling the first signal received by the first signal terminal when the shutdown signal is received by the second signal terminal, to generate a shutdown reference voltage; and a shutdown control unit, for generating the control signal according to the first signal and the shutdown reference voltage.

The present invention further discloses a power converter, for converting an input voltage to an output voltage. The power converter includes a control module, for providing a control signal; a power stage circuit, for receiving the input voltage, and providing the output voltage according to the control signal; and a soft-stop device, including a first signal terminal, for receiving a first signal corresponding to the output voltage; a second signal terminal, for receiving a shutdown signal for turning off the power converter; a discharging switch, coupled between the first signal terminal and a grounding terminal, for controlling an electrical connection between the first signal terminal and the grounding terminal according to a control signal; a sample-and-hold unit, coupled to the first signal terminal and the second signal terminal, for sampling the first signal received by the first signal terminal when the shutdown signal is received by the second signal terminal, to generate a shutdown reference voltage; and a shutdown control unit, for generating the control signal according to the first signal and the shutdown reference voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional power converter.

FIG. 2 is a schematic diagram of a power converter according to an embodiment of the present invention.

FIG. 3 is a detailed schematic diagram of the power converter shown in FIG. 1.

FIG. 4 is a timing schematic diagram of related signals of a soft-stop circuit operation of the power converter shown in FIG. 1.

FIG. 5 is a schematic diagram of a power converter according to an embodiment of the present invention.

FIG. 6A and FIG. 6B are schematic diagrams of power converters according to an embodiment of the present invention.

### DETAILED DESCRIPTION

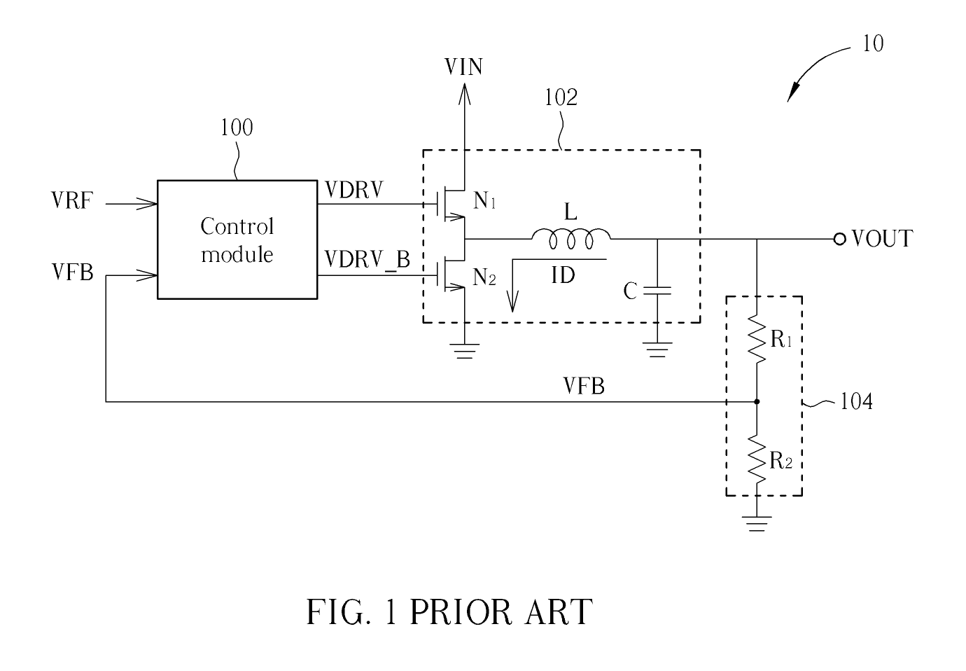

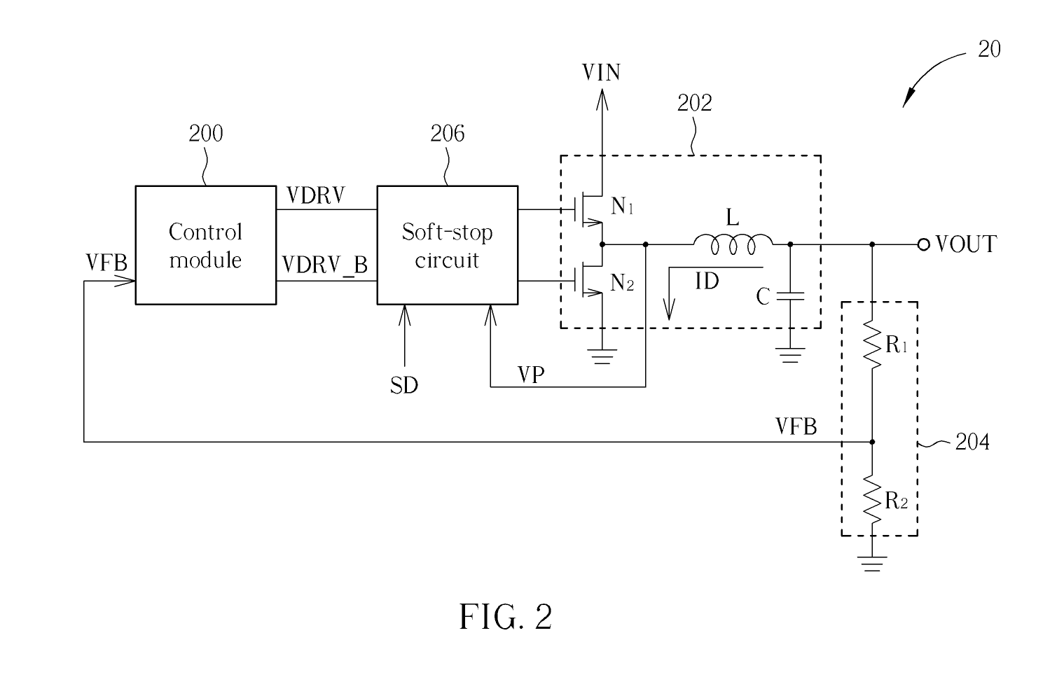

Please refer to FIG. 2, which is a schematic diagram of a power converter 20 according to an embodiment of the present invention. The power converter 20 is a switching-mode buck converter, which can convert an input voltage VIN to an output voltage VOUT of lower level. The power converter 20 comprises a control module 200, a power stage circuit 202, a feedback circuit 204 and a soft-stop circuit 206. The structure and operations of the control module 200, the power stage circuit 202 and the feedback circuit 204 are similar to those of the control module 100, the power stage circuit 102 and the feedback circuit 104 shown in FIG. 1, and the same components are denoted by the same symbols. Difference between the power converter 20 and the power converter 10 is that the power converter 20 further adds a soft-stop circuit 206, which can conduct the lower gate switch N2 according to the output voltage VOUT when shut down, to discharge the residual output voltage VOUT to zero, thereby avoiding circuit damaged or a countercurrent status of an inductor current flowing to a voltage input terminal.

In detail, the soft-stop circuit 206 can turn off the power converter 20 according to a shutdown signal SD. When the shutdown signal SD does not indicate shut down, the soft-stop circuit 206 is disabled, and the control module 200 is enabled, allowing the power converter 20 to perform normal voltage converting operations. When the shutdown signal SD indicates shut down, the control module 200 may be disabled, and the soft-stop circuit 206 is enabled, allowing the power converter 20 to stop the voltage converting operations, and perform soft-stop mechanism. At this moment, the soft-stop circuit 206 can control the lower gate switch N2 to be turned on according to a phase signal VP corresponding to the output voltage VOUT, and discharging the residual output voltage VOUT to the ground through a path of a discharge current ID via a negative feedback mechanism. In the prior art, the power converter 10 controls discharging mechanism during shut down according to the feedback signal VFB derived from dividing the output voltage VOUT, which causes residual voltage issue. In comparison, the power converter 20 directly utilizes the phase signal VP corresponding to the output voltage VOUT, and does not perform voltage dividing, thereby ensuring the output voltage VOUT to be fully discharged when shut down.

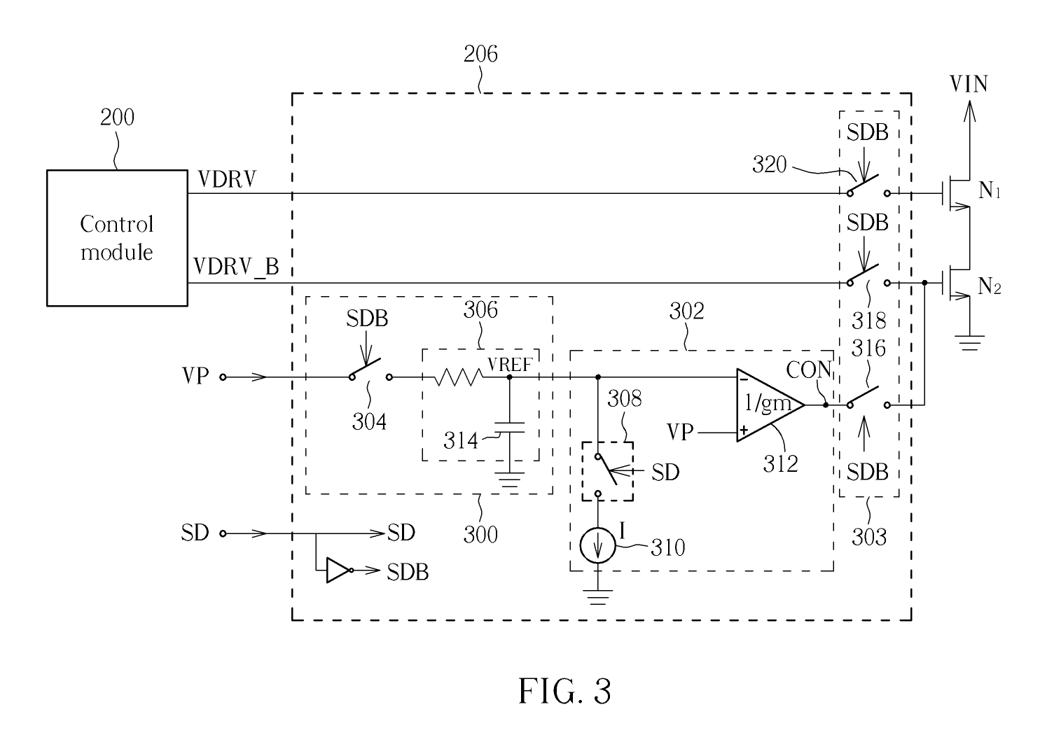

Furthermore, please refer to FIG. 3, which is a schematic diagram of an embodiment of the soft-stop circuit 206. In this embodiment, the soft-stop circuit 206 comprises a sample-and-hold unit 300, a shutdown control unit 302 and a switching unit 303. The switching unit 303 is formed by switches 316, 318 and 320, which control connections between the soft-stop circuit 206, the control module 200 and the power stage circuit 202 according to the shutdown signal SD (or an inverse signal SDB of the shutdown signal SD). The sample-and-hold unit 300 comprises a sample switch 304 and a voltage storage unit 306, which samples the phase signal VP as a shutdown reference voltage VREF when the shutdown signal SD indicates shut down (e.g. SD=1). The shutdown control unit 302 comprises a reference voltage discharging switch 308, a current source 310 and an operational amplifier 312, which discharges the shutdown reference voltage VREF, and compares the shutdown reference voltage VREF with the phase signal VP to generate a control signal CON, when the shutdown signal SD indicates shut down.

In detail, when the power converter 20 is in a normal converting operation (e.g. SD=0), the switching unit 303 conducts switches 318 and 320, and cuts off the switch 316; thus, the control module 200 is enabled, and the soft-stop circuit 206 is disabled. When the power converter 20 is shut down (SD=1), the switching unit 303 cuts off the switches 318 and 320, and conducts the switch 316; thus, the control module 200 is disabled, and the soft-stop circuit 206 is enabled. At this moment, the sample-and-hold unit 300 cuts off the sample switch 304, to sample the phase signal VP at the moment of shut down as the shutdown reference voltage VREF, and store the sampled phase signal VP in a capacitor 314 of the voltage storage unit 306. Then, the shutdown control unit 302 conducts the reference voltage discharge switch 308, to discharge the shutdown reference voltage VREF via a constant current I of the current source 310, such that the shutdown reference voltage VREF linearly falls to a grounding terminal voltage level. The control signal CON generated by the operational amplifier 312 can conduct the lower gate switch N2, and the phase signal VP is discharged to the ground through the path of the discharge current ID. Therefore, the operational amplifier 312 can force the phase signal VP of a positive input terminal of the operational amplifier 312 to vary with the shutdown reference voltage VREF of a negative input terminal via the negative feedback mechanism, leading the phase signal VP to follow the shutdown reference voltage VREF and linearly decrease to zero. In addition, when the power converter 20 stops converting operations, the switching unit 303 may disable the control module 200, and the upper gate switch N1 and the lower gate switch N2 of the power stage circuit 202 are in an OFF state; therefore, the inductor L equals a conducting wire at this moment, and the phase signal VP equals the output signal VOUT accordingly. Therefore, when the phase signal VP follows the shutdown reference voltage VREF and is linearly reduced to zero, the output voltage VOUT can also be linearly reduced to zero, and have no residual voltage.

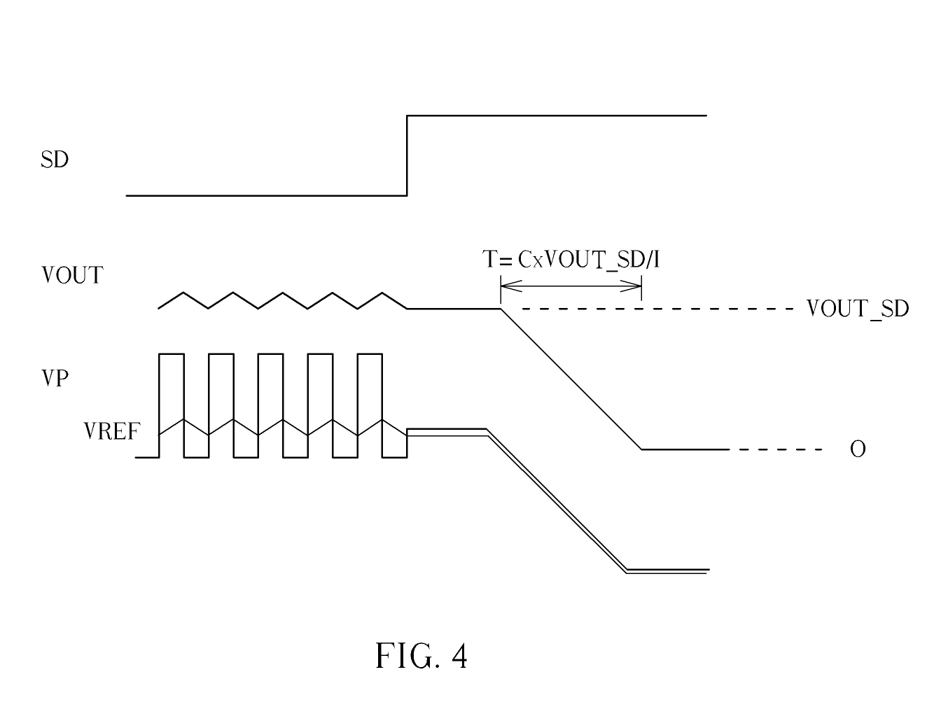

Please refer to FIG. 4, which is a timing schematic diagram of related signals when operating the soft-stop circuit 206 shown in FIG. 3. When the power converter 20 is not shut down (i.e. shutdown signal SD=0) and in the normal converting operation, waveforms of the output voltage VOUT, the phase signal VP and the shutdown reference voltage VREF are as shown in FIG. 4. When the power converter 20 is shut down (i.e. the shutdown signal SD=1), the phase signal VP stops fluctuation and equals the output voltage VOUT, and the sample-and-hold unit 300 samples and stores the output voltage VOUT as the shutdown reference voltage VREF at this moment. Subsequently, the reference voltage discharge switch 308 is conducted, and the current source 310 starts to discharge the shutdown reference voltage VREF stored in the sample-and-hold unit 300. Assuming a capacitor value of the capacitor 314 is C, and a current of the current source 310 is the constant current I, and a voltage of the output voltage VOUT at the moment of shut down is VOUT_SD, the shutdown reference voltage VREF is linearly reduced to 0 after a discharge time T. The discharge time T can be expressed as T=C*VOUT_SD/I.

Therefore, the soft-stop circuit 206 of FIG. 3 can directly sample the output voltage VOUT of the power converter 20 at the moment of shut down via the sample-and-hold unit 300, and by utilizing the shutdown control unit 302, the residual output voltage can be discharged to zero via the negative feedback mechanism when shut down. Note that, the soft-stop circuit 206 as shown in FIG. 3 is adapted to switching-mode buck applications, and the lower gate switch N2 is as a discharging switch when shut down. However, those skilled in the art may proper adjust the soft-stop circuit 206, to meet requirements of different applications. For example, in another embodiment, the soft-stop circuit 206 can remove the switching module 303. Furthermore, when the upper-lower gate structure is not applied in a power converter, the soft-stop circuit 206 has to add the discharging switch.

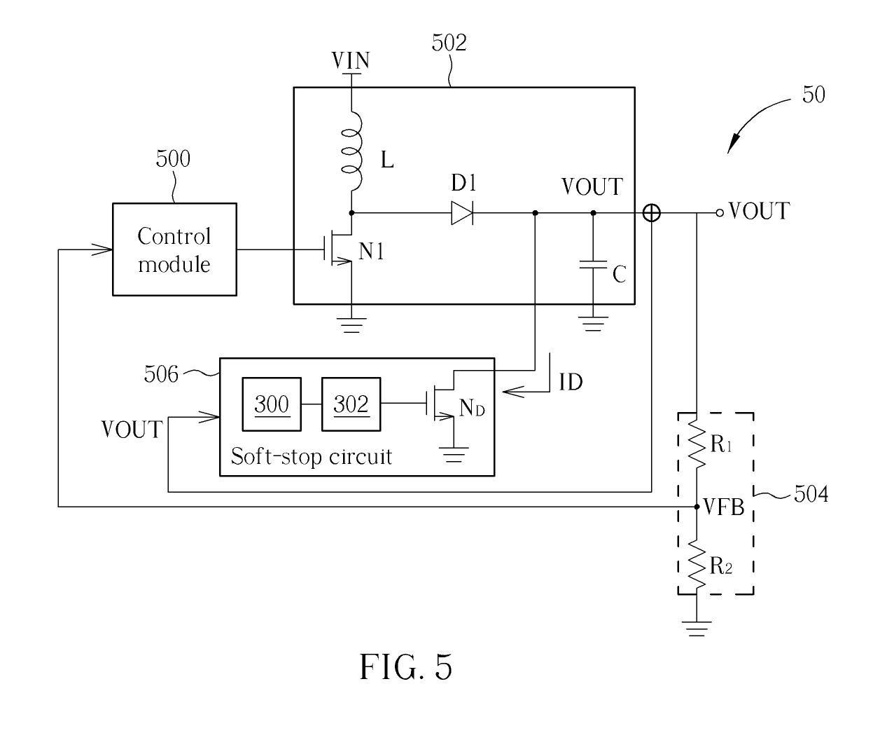

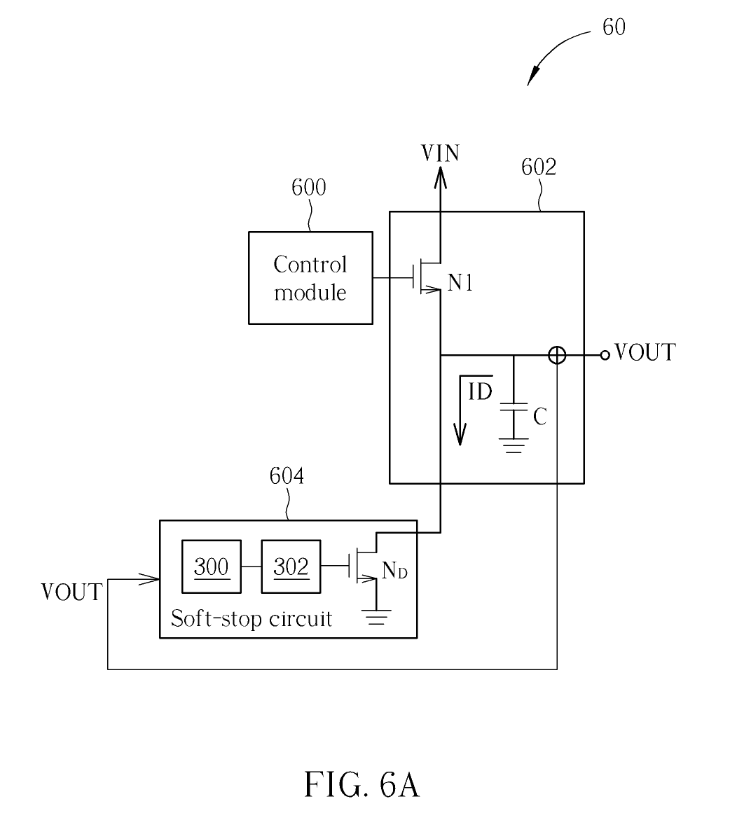

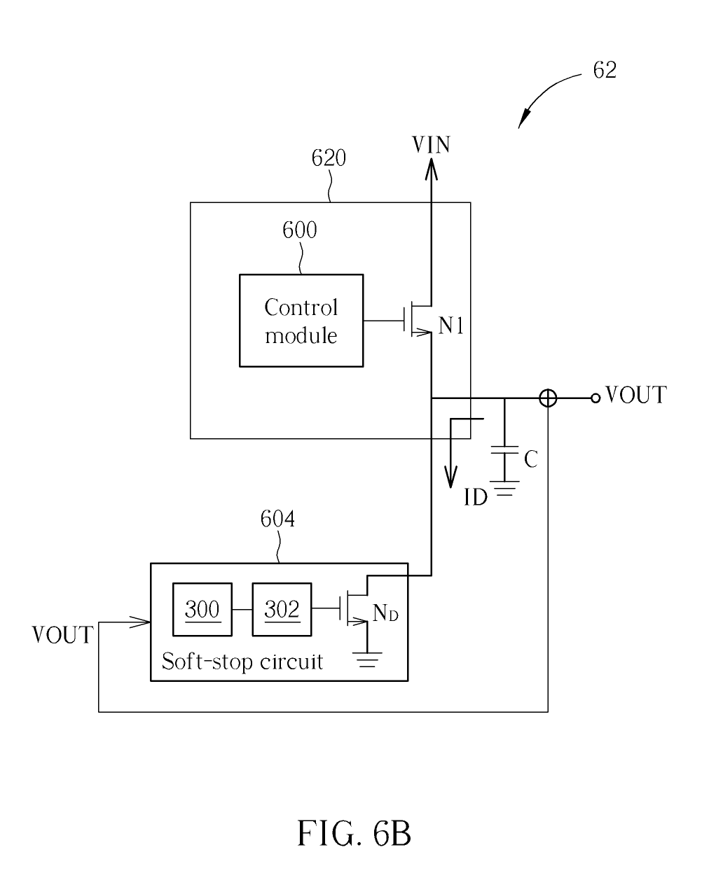

For example, please refer to FIG. 5, FIG. 6A and FIG. 6B, which are schematic diagrams of properly modifying and applying the soft-stop circuit 206 to different power converters according to different embodiments of the present invention. FIG. 5 is a schematic diagram of a power converter 50 according to an embodiment of the present invention. The power converter 50 comprises a control module 500, a power stage circuit 502, a feedback circuit 504 and a soft-stop circuit 506. The power converter 50 is a switching-mode boost converter, which can convert the input voltage VIN to the output voltage VOUT of higher level, and operations are well known by those skilled in the art, and are not narrated hereinafter. A structure of the soft-stop circuit 506 is similar to that of the soft-stop circuit 206 of FIG. 3, but the soft-stop circuit 506 does not include the switching module 303, and thus the same elements are denoted by the same symbols. In detail, the soft-stop circuit 506 comprises a discharging switch ND and the sample-and-hold unit 300 and the shutdown control unit 302 shown in FIG. 3. The difference between the soft-stop circuit 506 and the soft-stop circuit 206 shown in FIG. 2 is that since in the power converter 50, the inductor L included in the power-stage circuit 502 is located at an input voltage terminal rather than an output voltage terminal, the soft-stop circuit 506 can directly sample the voltage of the output capacitor C to obtain the output voltage VOUT without sampling the phase signal VP corresponding to the output voltage VOUT. In addition, since the power stage circuit 502 of the power converter 50 lacks a structure of the lower gate switch N2 included in the power converter 20, and needs to add the discharge switch ND, to discharge the output voltage VOUT remained in the output capacitor C to the ground via the path of the discharge current ID when shut down.

Please continue to refer to FIG. 6A and FIG. 6B. FIG. 6A is a schematic diagram of a power converter 60 according to another embodiment of the present invention. The power converter 60 comprises a control module 600, a power stage circuit 602 and a soft-stop circuit 604. The power converter 60 is a low-dropout (LDO) linear power converter, which can convert the input voltage VIN to the output voltage VOUT of lower level, and operations are well known by those skilled in the art, and are not narrated hereinafter. The soft-stop circuit 604 comprises the discharging switch ND and the sample-and-hold unit 300 and the shutdown control unit 302 shown in FIG. 3. The power converter 60 is not a switching-mode power converter, and lacks the inductor L included in the power converter 20. Therefore, the difference between the soft-stop circuit 604 and the soft-stop circuit 206 is that the soft-stop circuit 604 can directly sample the output voltage VOUT of the output capacitor C. In addition, the power stage circuit 602 lacks the structure of the lower gate switch N2 included in the power converter 20, and thus the soft-stop circuit 604 needs to add the discharge switch ND, to discharge the output voltage VOUT remained in the output capacitor C to the ground via the path of the discharge current ID when shut down. On the other hand, in another embodiment, the power transistor N1 of the power stage circuit 602 of the power converter 60 can also be disposed inside a control chip 620 including the control module 600, such as a power converter 62 as shown in FIG. 6B.

Note that, the spirit of the present invention is to directly sample the output voltage (or the signal corresponding to the output voltage) rather than only sample the signal after dividing the voltage of the output voltage as the reference voltage. Therefore, using the negative feedback mechanism, the residual output voltage can be discharged to zero when shut down, and may not generate a residual voltage related to a voltage-dividing ratio. Those skilled in the art may make alterations or modifications according to different applications. For example, the soft-stop circuit of the present invention is not limited for the switching-mode power converter or the linear power converter, and can be utilized for different devices, such as a power converter, a voltage regulator, and a power generator, etc. or any other applications requiring the output voltage to be returned to zero at each restart. In addition, as to sampling the output terminal to generate the reference voltage required by the shutdown circuit, it is preferable to directly sample the output voltage or sample a signal corresponding to the output voltage. In addition, the current source I of the shutdown control unit 302 and the value of the capacitor C of the sample-and-hold unit 300 both are determined based on system requirements, to fall the output voltage to zero with different speeds after shut down. The output voltage is not limited to be linearly reduced when shut down, and can also be reduced along a curve, as long as the output voltage can be gradually reduced and have no residual voltage after shut down.

To sum up, apart from sampling the signal generated by dividing the output voltage as the reference voltage in the prior art, the soft-stop circuit of the present invention directly samples the output voltage (or the signal corresponding to the output voltage). Therefore, when shut down, the power converter can discharge the residual output voltage to zero via the negative feedback, and may not generate the residual output voltage when the voltage-dividing ratio is higher.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A soft-stop device for a power converter utilized for converting an input voltage to an output voltage, comprising:
a first signal terminal, for receiving a first signal corresponding to the output voltage;
a second signal terminal, for receiving a shutdown signal for turning off the power converter;
a discharging switch, coupled between the first signal terminal and a grounding terminal, for controlling an electrical connection between the first signal terminal and the grounding terminal according to a control signal;
a sample-and-hold unit, coupled to the first signal terminal and the second signal terminal, for sampling the first signal received by the first signal terminal when the shutdown signal is received by the second signal terminal, to generate a shutdown reference voltage; and
a shutdown control unit, for generating the control signal according to the first signal and the shutdown reference voltage.

2. The soft-stop device of claim 1, wherein the sample-and-hold unit comprises:
a voltage storage unit, for storing the shutdown reference voltage; and
a sampling switch, coupled to the first signal terminal, the voltage storage unit and the second signal terminal, for maintaining a connection from the first signal terminal to the voltage storage unit when the shutdown signal is not received by the second signal terminal, and cutting off the connection from the first signal terminal to the voltage storage unit when the shutdown signal is received by the second signal terminal, to sample the first signal as the shutdown reference voltage.

3. The soft-stop device of claim 1, wherein the shutdown control unit comprises:
a current source, for providing a current;
an operational amplifier, comprising a negative input terminal coupled to the sample-and-hold unit, a positive input terminal coupled to the first signal terminal, and an output terminal, for comparing the first signal and the shutdown reference voltage, to output the control signal from the output terminal;
a reference voltage discharging switch, comprising a first terminal coupled between the sample-and-hold unit and the negative input terminal of the operational amplifier, a second terminal coupled to the current source, and a third terminal coupled to the second signal terminal, for conducting a connection from the first terminal to the second terminal when the shutdown signal is received by the second signal terminal, to discharge the shutdown reference voltage via the current source.

4. The soft-stop device of claim 1, wherein the power converter is a switching-mode buck converter, and the discharging switch is a lower gate switch of the switching-mode buck converter.

5. The soft-stop device of claim 4, further comprising a switching module, for maintaining a connection between a control module of the switching-mode buck converter and the lower gate switch, and cutting off a connection between the shutdown control unit and the lower gate switch, when the shutdown signal is not received by the second signal terminal, and cutting off the connection between the control module and the lower gate switch, and maintaining the connection between the shutdown control unit and the lower gate switch, when the shutdown signal is received by the second signal terminal.

6. The soft-stop device of claim 1, wherein the power converter is a linear power converter or a switching-mode boost power converter.

7. A power converter, for converting an input voltage to an output voltage, comprising:
a control module, for providing a control signal;
a power stage circuit, for receiving the input voltage, and providing the output voltage according to the control signal; and
a soft-stop device, comprising:
a first signal terminal, for receiving a first signal corresponding to the output voltage;
a second signal terminal, for receiving a shutdown signal for turning off the power converter;
a discharging switch, coupled between the first signal terminal and a grounding terminal, for controlling an electrical connection between the first signal terminal and the grounding terminal according to a control signal;
a sample-and-hold unit, coupled to the first signal terminal and the second signal terminal, for sampling the first signal received by the first signal terminal when the shutdown signal is received by the second signal terminal, to generate a shutdown reference voltage; and
a shutdown control unit, for generating the control signal according to the first signal and the shutdown reference voltage.

8. The power converter of claim 7, wherein the sample-and-hold unit comprises:
a voltage storage unit, for storing the shutdown reference voltage; and
a sampling switch, coupled to the first signal terminal, the voltage storage unit and the second signal terminal, for maintaining a connection from the first signal terminal to the voltage storage unit when the shutdown signal is not received by the second signal terminal, and cutting off the connection from the first signal terminal to the voltage storage unit when the shutdown signal is received by the second signal terminal, to sample the first signal as the shutdown reference voltage.

9. The power converter of claim 7, wherein the shutdown control unit comprises:
a current source, for providing a current;
an operational amplifier, comprising a negative input terminal coupled to the sample-and-hold unit, a positive input terminal coupled to the first signal terminal, and an output terminal, for comparing the first signal and the shutdown reference voltage, to output the control signal from the output terminal;
a reference voltage discharging switch, comprising a first terminal coupled between the sample-and-hold unit and the negative input terminal of the operational amplifier, a second terminal coupled to the current source, and a third terminal coupled to the second signal terminal, for conducting a connection from the first terminal to the second terminal when the shutdown signal is received by the second signal terminal, to discharge the shutdown reference voltage via the current source.

10. The power converter of claim 7, wherein the power converter is a switching-mode buck converter, and the discharging switch is a lower gate switch of the switching-mode buck converter.

11. The power converter of claim 10, further comprising a switching module, for maintaining a connection between the control module and the lower gate switch, and cutting off a connection between the shutdown control unit and the lower gate switch, when the shutdown signal is not received by the second signal terminal, and cutting off the connection between the control module and the lower gate switch, and maintaining the connection between the shutdown control unit and the lower gate switch, when the shutdown signal is received by the second signal terminal.

12. The power converter of claim 7, wherein the power converter is a linear power converter or a switching-mode boost power converter.
